(19) United States
(12) Patent Application Publication
(10) Pub. No.: US 2016/0226811 A1
(43) Pub. Date: Aug. 4, 2016

(54) SYSTEM AND METHOD FOR PRIORITY EMAIL MANAGEMENT

(71) Applicant: Groove Labs Inc., Mountain View, CA (US)

(72) Inventors: Alexander Sasha Kerschhofer, Mountain View, CA (US); Chris Rothstein, San Mateo, CA (US); Austin Wang, Bellevue, WA (US)

(21) Appl. No.: 15/011,056

(22) Filed: Jan. 29, 2016

Related U.S. Application Data
(60) Provisional application No. 62/110,270, filed on Jan. 30, 2015.

(51) Int. Cl. H04L 12/58; G06F 17/30

(52) U.S. Cl. CPC H04L 51/26; H04L 51/12; G06F 17/30867; G06F 17/30601

(57) ABSTRACT

This disclosure generally relate to a method and system for priority email management. The present technology relates to techniques enable an automatic management of emails based on data from both the email database and the customer information database. By utilizing data extracted from the customer database, some embodiments herein achieve an automatic and efficient e-mail management method and system.

### CROSS-REFERENCE TO RELATED APPLICATION

This application claims priority to U.S. Provisional Application 62/110,270, titled “EMAIL INBOX PRIORITIZATION AND MESSAGE RELEVANCY INDICATIONS” and filed at Jan. 30, 2015, the disclosure of which is incorporated herein by reference in its entirety.

### TECHNICAL FIELD

The disclosure relates generally to electronic mail (e-mail) management. More specifically, certain embodiments of the technology relate to a method and system for priority email management.

### BACKGROUND

Email inboxes are increasingly cluttered with unwanted advertisements (“spam”), personal electronic messages (“emails”), and work-related emails. With an increasing number of emails to process, a user expends an excessive amount of time reading through a mass of emails to determine which emails are relevant. Furthermore, some emails may cross categories such as a work category and a personal category. For example, an email from a personal friend may contain a message related to a user's work, such as a buyer contacting a friend to buy a product from the friend's business. Another example of category mixing occurs when an employee sends an email to a co-worker with a message related to a non-work matter, e.g., the employee can ask the co-worker to go for a jog after work.

Such complexity associated with the different categories of emails makes prioritization of emails difficult and causes a user to spend an exorbitant amount of time to process all of the emails and determine which are relevant to the user's goals. This is particularly difficult in a sales environment where many emails are received, but only some are relevant to the user in the sales environment.

### SUMMARY

Aspects of some embodiments disclose techniques that enable an automatic management of emails based on data from both the email database and the customer information database. By utilizing data extracted from the databases, some embodiments herein achieve an optimized and efficient e-mail management method and system.

Aspects of some embodiments disclose a computer-implemented method, comprising: receiving email data related to a recipient, the email data including a first plurality of email messages received at a chronological order, receiving customer data from a customer database related to the recipient, the customer data including sender information associated with the first plurality of email messages, determining a respective relevance score associated with each of the first plurality of email messages based at least in part on the email data and the customer data, the respective relevance score indicating a priority level of an email message relative to the recipient, selecting a second plurality of email messages from the first plurality of email messages based at least in part on the respective relevance score, and displaying the second plurality of email messages in a priority order reflecting priorities of the second plurality of email messages relative.

Aspects of some embodiments disclose a system comprising, one or more one or more processors; and memory including instructions that, upon being executed by the one or more processors, cause the system to: receive email data related to a recipient, the email data including a first plurality of email messages received at a chronological order, receive customer data from a customer database related to the recipient, the customer data including sender information associated with the first plurality of email messages, determine a respective relevance score associated with each of the first plurality of email messages based at least in part on the email data and the customer data, the respective relevance score indicating a priority level of an email message relative to the recipient, identify an inquiry indication associated with at least one email message, the inquiry indication associated with a high priority level of the at least one email message, generate a snippet associated with the inquiry indication, the snippet including a content of the inquiry indication, and display the snippet and the first plurality of email messages in a priority order reflecting priorities of the second plurality of email messages relative.

Although many of the examples herein are described with reference to email inbox managing, it should be understood that these are only examples and some embodiments are not limited in this regard. Rather, the present disclosure can manage and optimize displaying of various incoming data such as text messages, tweets, news feeds, video or image updates.

Additionally, even though the present disclosure uses Customer Relationship Management (CRM) as an example of the customer database, aspects of some embodiments are applicable to other types of customer-related database or sales database. Examples of such database include sales database, contact database, lead database, etc.

Additional features and advantages of the disclosure will be set forth in the description which follows, and, in part, will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

In order to describe the manner in which the above-recited and other advantages and features of the disclosure can be obtained, a more particular description of the principles briefly described above will be rendered by reference to specific examples thereof which are illustrated in the appended drawings. Understanding that these drawings depict only examples of the disclosure and are not therefore to be considered to be limiting of its scope, the principles herein are described and explained with additional specificity and detail through the use of the accompanying drawings in which:

FIG. 1 illustrates a schematic block diagram of a priority inbox system for an email recipient, according to some embodiments;

FIG. 2 illustrates an example of a user interface for the priority inbox system, according to some embodiments;

FIG. 3 illustrates another example of a user interface for the priority inbox system, according to some embodiments;

FIG. 4 illustrates yet another example of a user interface for the priority inbox system, according to some embodiments;

FIG. 5 is a flow diagram illustrating an example of a process for a priority inbox system, according to some embodiments;

FIG. 6 is another flow diagram illustrating an example of a process for a priority inbox system, according to some embodiments;

FIG. 7 illustrates an example computing device that can be used in accordance with various embodiments; and

FIG. 8 illustrates an environment in which various embodiments can be implemented, according to some embodiments.

### DESCRIPTION OF EXAMPLE EMBODIMENTS

Various embodiments of the present technology are discussed in detail below. While specific implementations are discussed, it should be understood that this is done for illustration purposes only. A person skilled in the relevant art will recognize that other components and configurations may be used without departing from the spirit and scope of the present technology.

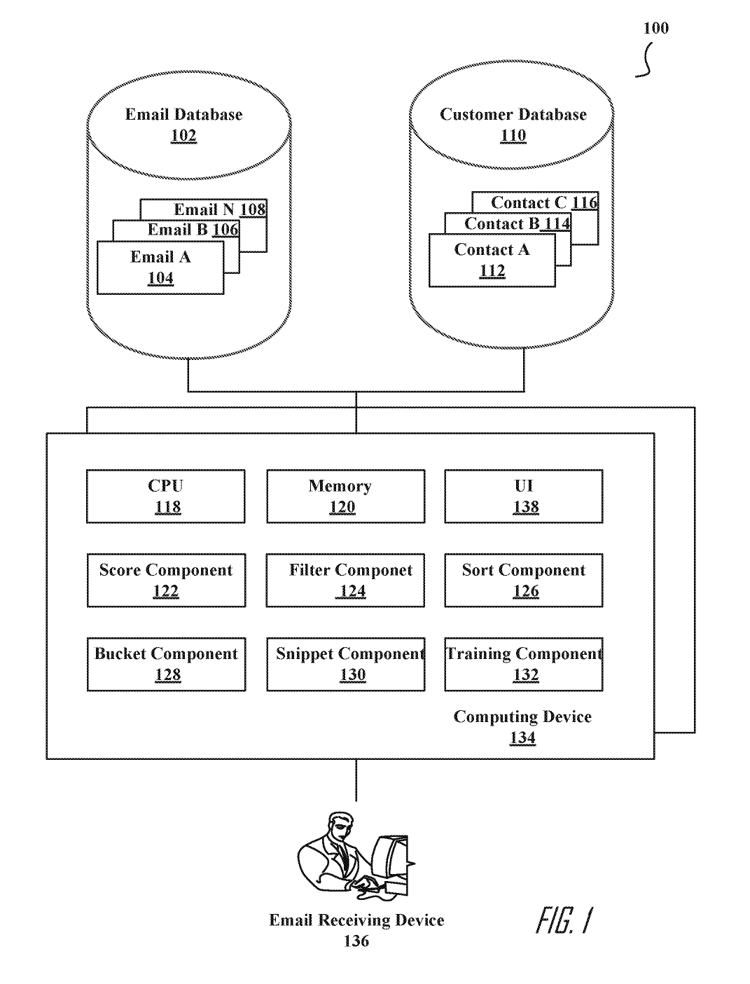

FIG. 1 illustrates a schematic block diagram of a priority inbox system 100 for an email recipient, according to some embodiments. FIG. 1 illustrates of priority inbox system 100, which can include, for example, Email Database 102, Customer Database 110, Computing Device 134 and Email Receiving Device 136. It should be appreciated that the system topology in FIG. 1 is an example, and any numbers of computing components may be included in the system of FIG. 1.

An email recipient, as shown in FIG. 1, can receive emails via Email Receiving Device 136, through a system and user interface such as Sales Priority Inbox (SPI) as disclosed herein. The SPI can provide an automatic mechanism of scoring, filtering, and bucketing emails according to its sales priority relative to the recipient. Email Receiving Device 136 can be one or more personal computers, phones, tablets, or servers that are operable to receive and process various data such as email data and customer data. Email Receiving Device 136 can include one or more Central Processing Units, e.g. CPU 118, that are operable to executed program instructions stored in a storage device, such as Memory 120. Additionally, Email Receiving Device 136 can be Computing Device 134, according to some embodiments.

Email Database 102 can include email data related to an email recipient or an email account, which can include a number of email messages that are received at a chronological order, e.g., Email A 104, Email B 106, and Email N 108. According to some embodiments, Email A 104 can be an individual email that is associated with a sender and one or more recipients, an email subject and a context body. Email A 104 can be associated with a message ID, which can be used to tie relevant messages to a thread and be indicated in the email header. An example of Email Database 102 is a Gmail email database. Additionally, Email Database 102 can be stored on one more local or networked computing devices, email servers or a combination thereof.

Customer Database 110 can include various types of customer data related to an email recipient or an email account. According to some embodiments, customer data includes business relationship data, lead data, account data, contact data, opportunity data, sales data, support data, order management data, supply chain and any other types of data that can be used to determine a relationship between the recipient and the email sender. An example of Customer Database 110 is a Salesforce database, a type of Customer Relationship Management (CRM) application. Customer Database 110 can allow a user to manage business relationships as well as the data associated with them. For example, Customer Database 110 can store present customers, prospect contact information, accounts, leads, sales opportunities and cases in database entries such as Contact A 112, Contact B 114 and Contact C 116. According to some embodiments, Contact A can include customer A's various business information, including without limited to, previous sales data, business size, or relationship data. Customer Database 110 can be stored on one more local or networked computing devices, email servers or a combination thereof.

According to some embodiments, the analysis of the email data and the customer data can determine relationships by matching the name of a person from the sales database to an email sender identified in the email server database. For example, Priority Inbox System 100 can determine that Email A 104 is sent from a person whose name matches Contact A 112 as stored in Customer Database 110. Thus, the sender of Email A 104 is a customer of the Email recipient. Further, various identification information, including the sender's email address or the email domain, can be used to determine the relationship.

According to some embodiments, Priority Inbox System 100 can filter or remove non-business relevant emails using Filter Component 124. Filter Component 124 can include one or more algorithms operable to remove an email from the priority inbox. Examples of non-business relevant emails include internal emails, commercial promotions, social updates, and forum news. For example, an internal email can be determined by matching the email domain of the sender to the email domain of the recipient, indicating a colleague relationship between the two. Other non-business relevant emails can be identified by maintaining a blacklist of certain senders such as business-promoting websites, social network websites, online dating websites, email groups, etc. Alternatively, the system can search for other information such as an unsubscribe link or rich HTML layouts. According to some embodiments, Priority Inbox System 100 can leverage the existing filters of the email application, e.g., Gmail. According to some embodiments, Priority Inbox System 100 can enable a user to adjust the filter to remove or block certain senders.

To assist the Email recipient to focus on the most important emails (e.g., emails from customers), Score Component 122 is operable to calculate a respective relevance score of each email, which indicates a priority level of the email relative to the recipient. According to some embodiments, a relevance score can be calculated based on comparing information of email messages in an email thread to indicate how the recipient is related to the sender. For example, Priority Inbox System 100 can first iterate through inbox emails to extract all email address of the senders and recipients. According to some embodiments, the system can iterate through the filtered inbox emails which have removed non-business relevant emails. Priority Inbox System 100 can then try to locate related records in Customer Database 110, which can include CRM information such as leads, contacts, accounts, opportunities, cases, etc. Once a match is identified, the system can, replying on multiple attributes of the relationship, calculate a relevance score to the email. According to some embodiments, a numeric value of the relevance score is proportional to the priority or importance of the email. For example, a related open opportunity wherein an owner is the user or the recipient can be assigned 100 points; a related open opportunity wherein an owner is not the user or the recipient can be assigned 70 points; a related open case wherein an owner is the user or the recipient can be assigned 100 points; and a related open opportunity wherein an owner is not the user or the recipient can be assigned 70 points. When one email thread contains more than one senders or recipients, the system can select the strongest rule that renders the highest relevance score.

According to some embodiments, Priority Inbox System 100 can, using relationship tagging, determine a type of contact for the email sender and display a corresponding tag next to the email. For example, by analyzing the customer database entries in conjunction with the email context, an email can be tagged as an opportunity type or a contact type.

After the scoring of each email, Priority Inbox System 100 can select a second number of emails based on the email's relevance score. For example, the system can select emails with relevance scores higher than a specified threshold, e.g., 30 points. According to some embodiments, the second number of email can include all the emails in the inbox. According to some embodiments, when a relevance score of an email is substantially lower than other emails, the system can filter it from the inbox email, resulting in a smaller number of emails to be displayed.

Further, Priority Inbox System 100 can display the selected emails in a priority order that reflects priorities of the emails on a user interface, e.g., UI 138. For example, Sort Component 126 can generate the priority order by sorting the relevance scores of the emails, for example, in a descending order.

Bucket Component 128 can divide email messages into a number of categories that require distinctive or different actions of the recipient. For example, the categories can include a business inbox category that needs the recipient's general reviews, a follow-up category that requires the recipient's follow up, a “reply-required” category that indicates a response of the recipient is required.

According to some embodiments, the business inbox category or bucket can contain all email messages that have been filtered to remove non-business relevant emails. The business inbox category can display these emails pursuant to the relevance scores of the emails. Accordingly, the automatically generated categories can improve the recipient's efficiency in email processing.

According to some embodiments, the follow-up category can include sent emails that require the user, or the email sender, to take further actions. The follow-up category thus allows the user to revisit the previously sent emails and, if necessary, send out reminders to the recipient. For example, priority inbox system 100 can, by analyzing content of an email sent out by the user, determine that the user is expecting a reply from the recipient. Particularly, the system can search for any inquiry signal or indication, e.g., a question mark or a combination of words that indicate the sender has asked a question. For example, a NLP parser can be used to find inquiry indications. Further, the system can generate a snippet, or a brief extract, of the inquiry signal for displaying.

According to some embodiments, the rely-required category can comprise emails that require the user, or the email recipient, to answer one or more questions. For example, priority inbox system 100 can analyze the content of a received email and determine that the sender is expecting a reply from the user. Similarly, the system can search for any inquiry signal, e.g., a question mark or a combination of words that indicate the sender has asked a question. Further, the system can generate a snippet, or a brief extract, of the inquiry signal for displaying to the user. According to some embodiments, to reduce the number of emails, the system can further exclude emails between the user and his colleagues from the selected category.

Snippet Component 130 can generate a “call to action” snippet that highlights the major question of the email. For example, if the email sender has asked a question to the user or recipient and is expecting an answer, the snippet can be a brief extract of the question, an excerpt of the question, or a combination of the two. When there are multiple questions to be answered, several snippets can be generated and displayed. According to some embodiments, the system can utilize various natural language processing (NLP) technology, e.g., Penn Tree Bank II Tags, to determine the content of the email. NLP technology is well known by those skilled in the art so that further description thereof is unnecessary.

For example, to generate a snippet, priority inbox system 100 can, using a NPL part-of speech tagger, parse a first number of sentences, with the number adjustable by the user. When only one direct question introduced by a wh-word or a wh-phrase, a so-called SBARQ clause is identified, the system can generate a snippet based on the SBARQ clause, e.g. “When can we talk about details?”

When more than one SBARQ clauses are identified, the system can determine one or more clauses with higher likelihood of importance by searching for a particular sequence of clauses. According to some embodiments, a clause with a structure of a noun phrase (NP) followed by a verb phrase (VP) that is in the form of “verb base form” (VB) or “non-3^{rd} person singular present” (VBP) is generally more important than other non-conforming clauses. (e.g., when can we talk about the details?).

When the system cannot identify any SBARQ clauses, the system can try to identify implied request, e.g., “Send us the price list.” According to some embodiments, the system can select the first sentence that includes a verb phrase (VP) in which the verb is the base form and the first (phrase level) child node is a noun phrase (NP), or the second child node is a NP when the first child node is a particle node (PRT). Subsequently, the system can iterate upwards the parse tree from the VP and select the first sentence that meets one of the three criteria: 1. The VB is the root node, e.g., “Send more data so we can move forward.”); 2. The closest ancestor NP is in the form of “second person singular/plural”, (i.e. you), e.g., “You should send us the form by tomorrow.”; and 3. There is an ancestor node that is an “interjection” (INTJ/UH), e.g., “If you want to proceed, please fill out the form by tomorrow.”

According to some embodiments, priority inbox system 100 can generate a snippet based on the first sentence when it cannot identify any priority sentence. Additionally, the system can remove courtesy phrases such as “how are you doing?” even though it has a question mark is identified.

Training Component 132 can automatically train the priority inbox model by receiving and analyzing user data. For example, the system can receive user input data, e.g., which emails were actually processed by the user first, and use such feedbacks to train and improve the priority inbox system by adjusting weights of various factors of the respective relevance score. The system can also receive user history data over a period of time for the training purpose, e.g. over a selected period of time. According to some embodiments, the system can utilize machine learning technology to train the priority inbox model.

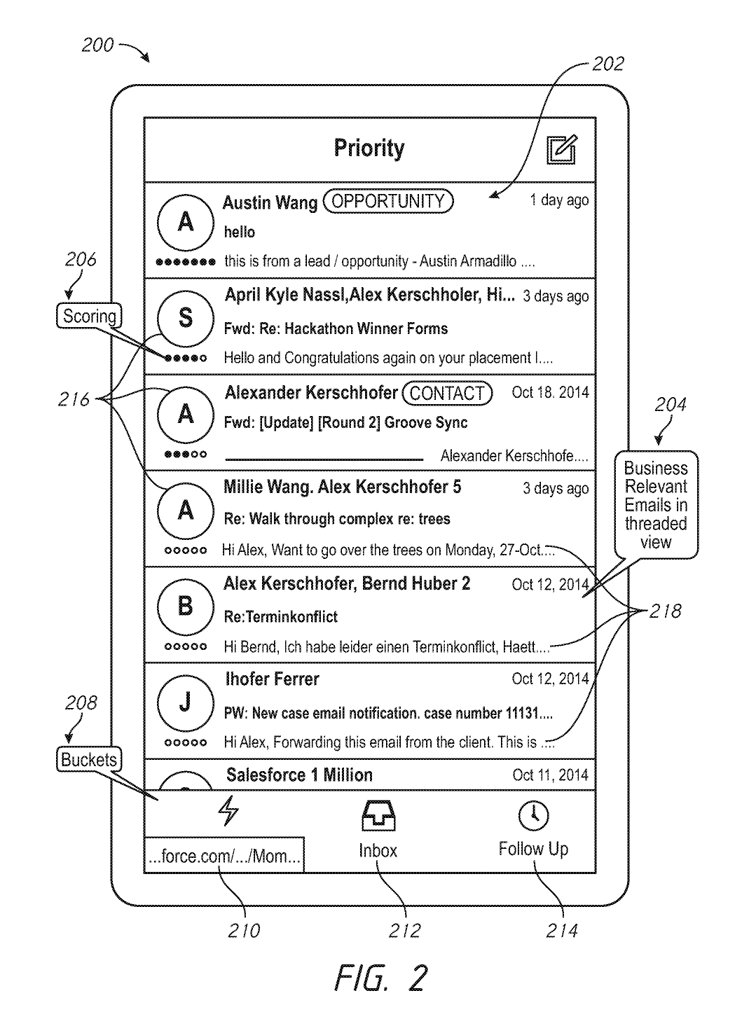

FIG. 2 illustrates an example of a user interface 200 for the priority inbox system, according to some embodiments. User interface 200 can be hosted by any type of suitable computing device, such as a personal computer, a phone, a tablet, or any combination thereof. According to some embodiments, the priority inbox system can reorganize the user's emails and present in an optimized user interface which emphasizes the priorities of the emails.

Emails related to a recipient or a user can include business-relevant or non-business relevant emails. For example, the priority inbox system can first iterate through inbox emails to extract all email address of the senders and recipients, leaving only business relevant emails 204. According to some embodiments, the system can iterate through the filtered inbox emails which have removed non-business relevant emails. Examples of non-business relevant emails include internal emails, commercial promotions, social updates, and forum news. For example, an internal email can be determined by matching the email domain of the sender to the email domain of the recipient, indicating a colleague relationship between the two. Other non-business relevant emails can be identified by maintaining a blacklist of certain senders such as business-promoting websites, social network websites, online dating websites, email groups, etc. Alternatively, the system can search for other information such as an unsubscribe link or rich HTML layouts.

The priority inbox system can calculate a respective relevance score 206 of each email, which indicates a priority level of the email relative to the recipient. According to some embodiments, a relevance score can be calculated based on comparing information of an email message to its relevant information in the customer database to indicate how the recipient is related to the sender. For example, for each inbox email, the priority inbox system can try to locate its related records in a customer database, which can include CRM information such as leads, contacts, accounts, opportunities, cases, etc. Once a match is identified, the system can, replying on multiple attributes of the relationship, calculate a relevance score to the email. According to some embodiments, a numeric value of the relevance score is proportional to the priority or importance of the email. For example, a related open opportunity wherein an owner is the user or the recipient can be assigned 100 points; a related open opportunity wherein an owner is not the user or the recipient can be assigned 70 points; a related open case wherein an owner is the user or the recipient can be assigned 100 points; and a related open opportunity wherein an owner is not the user or the recipient can be assigned 70 points. When one email thread contains more than one senders or recipients, the system can select the strongest rule that renders the highest relevance score.

The priority inbox system can display the emails in a priority order that reflects priorities of the emails on user interface 200, for example, in a priority order generated by sorting the relevance scores of the emails, for example, in a descending order. As illustrated in FIG. 2, the score of the first email from Austin Wang is higher or at least equivalent to the score of the second email from April Kyle Nassl and others.

According to some embodiments, after the scoring of each email, the priority inbox system can select a number of emails based on the email's relevance score. For example, the system can select emails with relevance scores higher than a specified threshold, e.g., 30 points. According to some embodiments, the selected number of email can include all the emails in the inbox. According to some embodiments, when a relevance score of an email is substantially lower than other emails, the system can filter it from the inbox email, resulting in a smaller number of emails to be displayed.

The priority inbox system can divide email messages into a number of categories or buckets 208 that require distinctive or different actions of the recipient. For example, the categories can include a business inbox category 212 that needs the recipient's general reviews, a follow-up category 214 that requires the recipient's follow up, a “reply-required” category 210 that indicates a response of the recipient is required.

Business inbox category 212 can contain all email messages that have been filtered to remove non-business relevant emails. The business inbox category can display these emails pursuant to the relevance scores of the emails. Accordingly, the automatically generated categories can improve the recipient's efficiency in email processing.

Follow-up category 214 can include sent emails that require the user, or the email sender, to take further actions. The follow-up category thus allows the user to revisit the previously sent emails and, if necessary, send out reminders to the recipient. For example, priority inbox system can, by analyzing content of an email sent out by the user, determine that the user is expecting a reply from the recipient. Particularly, the system can search for any inquiry signal or indication, e.g., a question mark or a combination of words that indicate the sender has asked a question. Further, the system can generate a snippet, or a brief extract, of the inquiry signal for displaying.

Reply-required category 210 can comprise emails that require the user, or the email recipient, to answer one or more questions. For example, priority inbox system can analyze the content of a received email and determine that the sender is expecting a reply from the user. Similarly, the system can search for any inquiry signal, e.g., a question mark or a combination of words that indicate the sender has asked a question. Further, the system can generate a snippet, or a brief extract, of the inquiry signal for displaying to the user. According to some embodiments, to reduce the number of emails, the system can further exclude emails between the user and his colleagues from the selected category.

According to some embodiments, object indicators 216 can indicate relationships based on comparison of data from a customer database, e.g., a CRM database, with email data in the user's inbox. In this exemplary embodiment, the letters “A”, “S”, “B”, and “J” can indicate relationships such as Lead, Contact, Opportunity, and Unknown. It is understood that other relationships may be determined and substituted or added to inform the user of the user's relationship to the sender, based on the analyzed CRM data. Other symbols may also be used to quickly give the user a quick indication of a relationship to a sender, such as stars, emoticons, human shapes, folder images, crowns, flags, and the like.

As illustrated in FIG. 2, snippet(s) 218 can display important text or content from an email. These snippets 218 may be shown in addition to a subject line as shown in this exemplary embodiment, or the snippets 218 may replace the subject line in an email inbox. The message snippets 218 may display a question that requires a response, allowing a user to quickly identify an important aspect of an email without having to open the email message. This is a time-saving feature as subject lines are not always helpful to identify what will be important in a message. This can happen due to email message chains/thread where the subject of the email conversation changes from the original subject of the subject line. Using the present technology, even if the subject of the email conversations changes during the course of the email exchanges, a user will quickly know what requires reply from a message without opening the message. For example, an email thread/chain may begin with a subject line of “Presentation Slides” but the conversation may then shift to discussion regarding a meeting time. A last message in the email thread may ask “Can you meet at 4:00 PM?” The snippet 218 related to that email may list “Can you meet at 4:00 PM?” in message snippet 218 area of the email inbox so that the recipient user may respond immediately without having to open the email message to read the entire contents of the message.

One of ordinary skill will readily appreciate that other parts of an email message or a suggested action may be presented by the message snippets 218 in addition to questions presented to the recipient. For example, if using follow up category 214, a message snippet may list a portion of text related to a message that includes information that should be followed up on, such as a message from a prospective client that states, “I′ll get back to you at the end of January after talking with my CEO.” That sentence, “I′ll get back to you at the end of January after talking with my CEO,” may then be prioritized in the follow up category 214 based on the date for follow up (the end of January, January 31) and the relationship to the user recipient. The message snippet 218 related to the email may show “I′ll get back to you at the end of January after talking with my CEO” or it may offer a suggested action for the recipient user based on the context of the email. For example, the message snippet 218 can read “Follow up with sender on January 31.” Other types of suggested actions such as “Send meeting reminder tomorrow,” “Reserve conference room for Tuesday at 3:00 PM,” or any other suggested action related to an email message may be shown by the message snippet 218.

The priority inbox system can, using relationship tagging, determine a type of contact for the email sender and display a corresponding tag 202 next to the email. For example, by analyzing the customer database entries in conjunction with the email context, an email can be tagged as an opportunity type or a contact type.

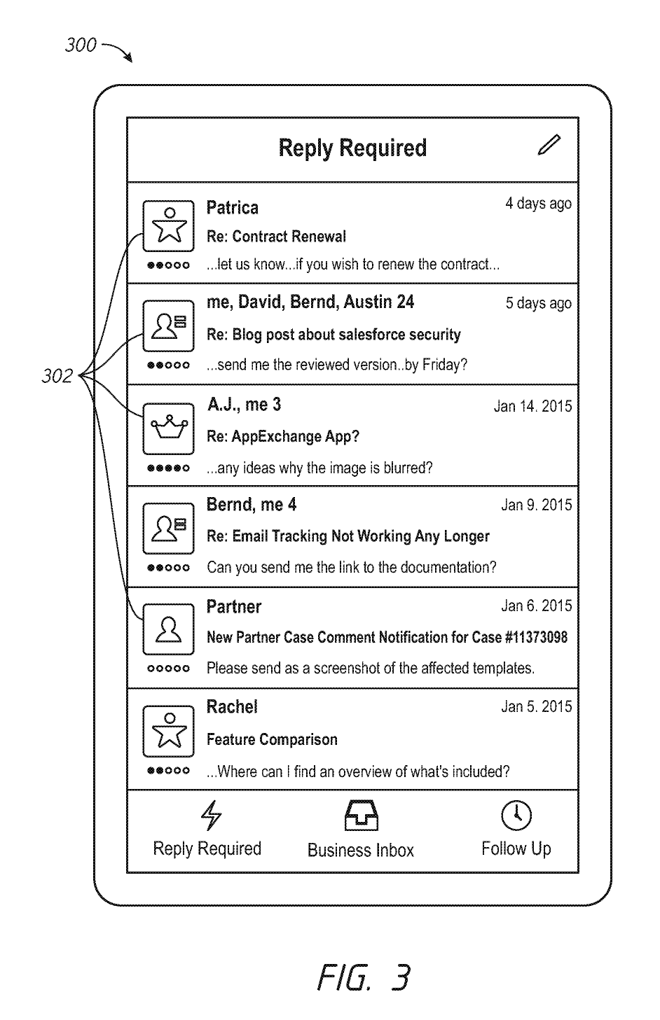

FIG. 3 illustrates another example of a user interface 300 for the priority inbox system, according to some embodiments. The priority inbox system can divide email messages into a number of categories or buckets that require distinctive or different actions of the recipient. For example, the categories can include a “reply-required” category that indicates a response of the recipient is required.

Reply-required category can comprise emails that require the user, or the email recipient, to answer one or more questions. For example, priority inbox system can analyze the content of a received email and determine that the sender is expecting a reply from the user. Similarly, the system can search for any inquiry signal, e.g., a question mark or a combination of words that indicate the sender has asked a question. Further, the system can generate a snippet, or a brief extract, of the inquiry signal for displaying to the user.

Object indicators 302 can indicate relationships based on comparison of data from a customer database, e.g., a CRM database, with email data in the user's inbox. In this exemplary embodiment, the letters “A”, “S”, “B”, and “J” can indicate relationships such as Lead, Contact, Opportunity, and Unknown. It is understood that other relationships may be determined and substituted or added to inform the user of the user's relationship to the sender, based on the analyzed CRM data. Other symbols may also be used to quickly give the user a quick indication of a relationship to a sender, such as stars, emoticons, human shapes, folder images, crowns, flags, and the like.

The priority inbox system can generate a “call to action” snippet that highlights the major question of the email. For example, if the email sender has asked a question to the user or recipient and is expecting an answer, the snippet can be a brief extract of the question, an excerpt of the question, or a combination of the two. When there are multiple questions to be answered, several snippets can be generated and displayed. According to some embodiments, the system can utilize various natural language processing (NLP) technology, e.g., Penn Tree Bank II Tags, to determine the content of the email.

For example, to generate a snippet, the priority inbox system can parse a first number of sentences, with the number adjustable by the user. When only one direct question introduced by a wh-word or a wh-phrase, a so-called SBARQ clause is identified, the system can generate a snippet based on the SBARQ clause, e.g. “When can we talk about details?”. When more than one SBARQ clauses are identified, the system can determine one or more clauses with higher likelihood of importance by searching for a particular sequence of clauses. When the system cannot identify any SBARQ clauses, the system can try to identify implied request, e.g., “Send us the price list.”

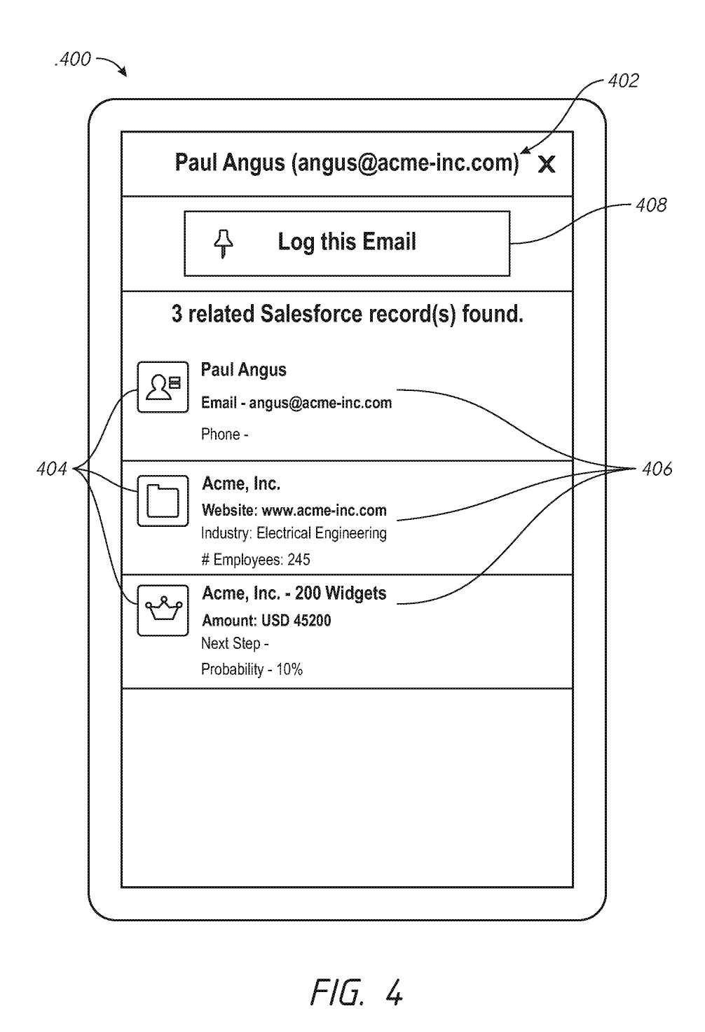

FIG. 4 illustrates yet another example of a user interface 400 for the priority inbox system, according to some embodiments. A contact or sender 402 with an associated email address is shown. The priority inbox system determines that three CRM object indicators 404 with related information 406 are possibly related to contact 402, based on information retrieved from a customer/CRM database. For example, the domain name of the contact is “acme-inc.com,” which is related to the three different types of object indicators 404 based on the domain name. The user or recipient may select from at least one of the object indicators 404 in order to associate a contact 402 with at least one of the object indicators 404 by selecting the “Log this Email” feature 408. As a result, the priority inbox system can be trained as to associate an email sender and the email message with information records already retrieved from the CRM database, thereby providing the user with convenience of not having to cross-reference databases in order to find all pertinent information related to a contact.

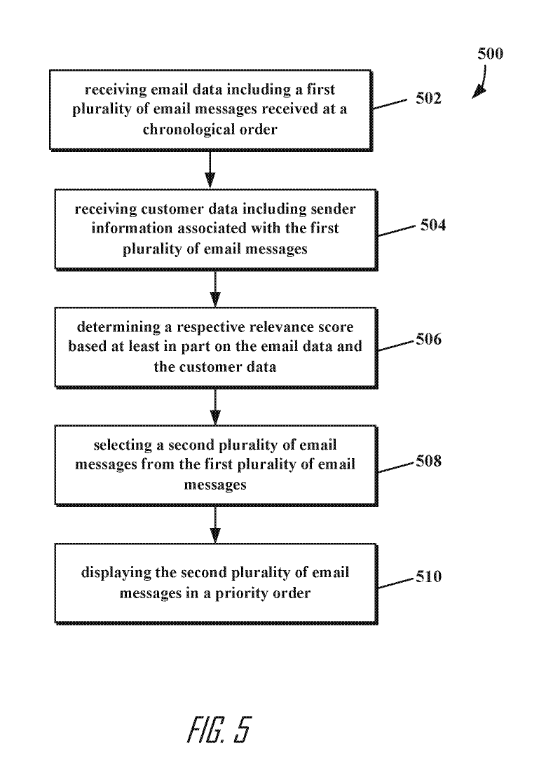

FIG. 5 is a flow diagram 500 illustrating an example of a process for a priority inbox system, according to some embodiments. It should be understood that there can be additional, fewer, or alternative steps performed in similar or alternative orders, or in parallel, within the scope of the various embodiments unless otherwise stated.

At step 502, a priority inbox system can receive email data related to a recipient, the email data including a first plurality of email messages received at a chronological order. For example, as illustrated in FIG. 1, Email Database 102 can include email data related to an email recipient or an email account, which can include a number of email messages that are received at a chronological order, e.g., Email A 104, Email B 106, and Email N 108. According to some embodiments, Email A 104 can be an individual email that is associated with a sender and one or more recipients, an email subject and a context body. Email A 104 can be associated with a message ID, which can be used to tie relevant messages to a thread and be indicated in the email header. An example of Email Database 102 is a Gmail email database.

At step 504, the priority inbox system can receive customer data from a customer database related to the recipient, the customer data including sender information associated with the first plurality of email messages. For example, Customer Database 110 can include various types of customer data related to an email recipient or an email account. According to some embodiments, customer data includes business relationship data, lead data, account data, contact data, opportunity data, sales data, support data, order management data, supply chain and any other types of data that can be used to determine a relationship between the recipient and the email sender. An example of Customer Database 110 is a Salesforce database, a type of Customer Relationship Management (CRM) application. Customer Database 110 can allow a user to manage business relationships as well as the data associated with them.

At step 506, the priority inbox system can determine a respective relevance score associated with each of the first plurality of email messages based at least in part on the email data and the customer data, the respective relevance score indicating a priority level of an email message relative to the recipient. For example, Priority Inbox System 100 is operable to calculate a respective relevance score of each email, which indicates a priority level of the email relative to the recipient. According to some embodiments, a relevance score can be calculated based on comparing information of an email message to its relevant information in the customer database to indicate how the recipient is related to the sender.

At step 508, the priority inbox system can select a second plurality of email messages from the first plurality of email messages based at least in part on the respective relevance score. For example, Priority Inbox System 100 can select a second number of emails based on the email's relevance score. For example, the system can select emails with relevance scores higher than a specified threshold, e.g., 30 points. According to some embodiments, the second number of email can include all the emails in the inbox. According to some embodiments, when a relevance score of an email is substantially lower than other emails, the system can filter it from the inbox email, resulting in a smaller number of emails to be displayed.

At step 510, the priority inbox system can display the second plurality of email messages in a priority order reflecting priorities of the second plurality of email messages relative. For example, Priority Inbox System 100 can display the selected emails in a priority order that reflects priorities of the emails on a user interface, e.g., UI 138. For example, Sort Component 126 can generate the priority order by sorting the relevance scores of the emails, for example, in a descending order.

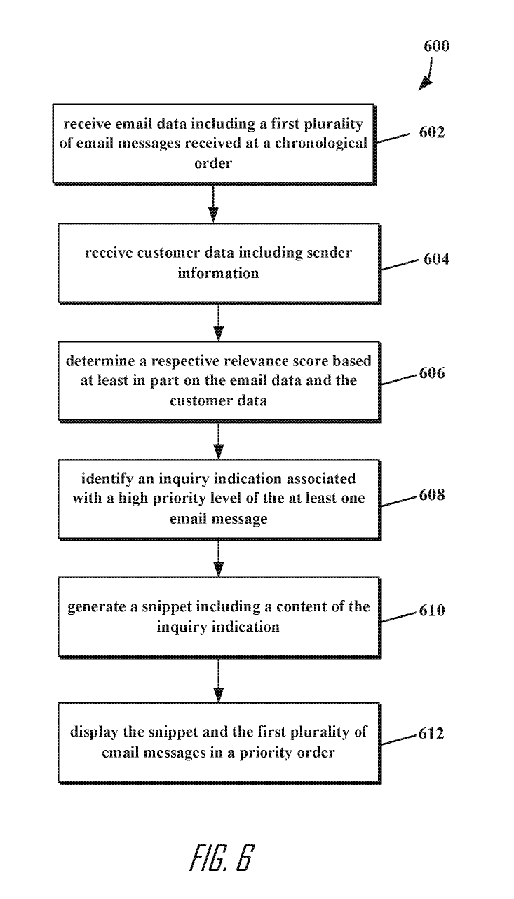

FIG. 6 is another flow diagram illustrating an example of a process 600 for a priority inbox system, according to some embodiments. It should be understood that there can be additional, fewer, or alternative steps performed in similar or alternative orders, or in parallel, within the scope of the various embodiments unless otherwise stated.

At step 602, a priority inbox system can receiving email data related to a recipient, the email data including a first plurality of email messages received at a chronological order. For example, as illustrated in FIG. 1, Email Database 102 can include email data related to an email recipient or an email account, which can include a number of email messages that are received at a chronological order, e.g., Email A 104, Email B 106, and Email N 108. According to some embodiments, Email A 104 can be an individual email that is associated with a sender and one or more recipients, an email subject and a context body. Email A 104 can be associated with a message ID, which can be used to tie relevant messages to a thread and indicated in the email header. An example of Email Database 102 is a Gmail email database.

At step 604, the priority inbox system can receive customer data from a customer database related to the recipient, the customer data including sender information associated with the first plurality of email messages. For example, Customer Database 110 can include various types of customer data related to an email recipient or an email account. According to some embodiments, customer data includes business relationship data, lead data, account data, contact data, opportunity data, sales data and any other types of data that can be used to determine a relationship between the recipient and the email sender. An example of Customer Database 110 is a Salesforce database, a type of Customer Relationship Management (CRM) application. Customer Database 110 can allow a user to manage business relationships as well as the data associated with them.

At step 606, the priority inbox system can determine a respective relevance score associated with each of the first plurality of email messages based at least in part on the email data and the customer data, the respective relevance score indicating a priority level of an email message relative to the recipient. For example, Priority Inbox System 100 is operable to calculate a respective relevance score of each email, which indicates a priority level of the email relative to the recipient. According to some embodiments, a relevance score can be calculated based on comparing information of email messages in an email thread to indicate how the recipient is related to the sender.

At step 608, the priority inbox system can identify an inquiry indication associated with at least one email message, the inquiry indication associated with a high priority level of the at least one email message. For example, Priority Inbox System 100 can analyze the content of a received email and determine that the sender is expecting a reply from the user. Similarly, the system can search for any inquiry signal, e.g., a question mark or a combination of words that indicate the sender has asked a question.

At step 610, the priority inbox system can generate a snippet associated with the inquiry indication, the snippet including a content of the inquiry indication. For example, Priority Inbox System 100 can generate a snippet, or a brief extract, of the inquiry signal for displaying to the user can generate a “call to action” snippet that highlights the major question of the email. If the email sender has asked a question to the user or recipient and is expecting an answer, the snippet can be a brief extract of the question, an excerpt of the question, or a combination of the two. According to some embodiments, priority inbox system 100 can generate a snippet based on the first sentence when it cannot identify any priority sentence. Additionally, the system can remove courtesy phrases such as “how are you doing?” even though it has a question mark is identified.

At step 610, the priority inbox system can display the snippet and the first plurality of email messages in a priority order reflecting priorities of the second plurality of email messages relative. For example, Priority Inbox System 100 can display the snippet and the email messages via UI 138.

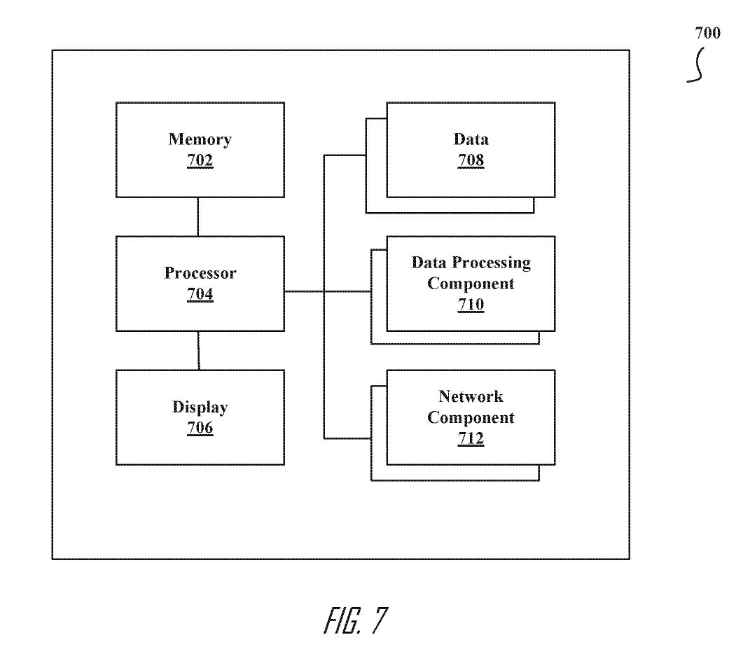

FIG. 7 illustrates an example computing device 700 that can be used in accordance with various embodiments. The computing device 700 includes a processor 704 for executing instructions that can be stored in a memory 702. As would be apparent to one of ordinary skill in the art, the memory component can include many types of memory, data storage, or non-transitory computer-readable storage media, such as a first data storage for program instructions for execution by the processor 704, a separate storage for images or data, a removable memory for sharing information with other devices, etc. The device typically will include some type of display element 706, such as a touchscreen, electronic ink (e-ink), organic light emitting diode (OLED), liquid crystal display (LCD), etc., although devices such as portable media players might convey information via other means, such as through audio speakers. In at least some embodiments, the display element 706 provides for touch or swipe-based input using, for example, capacitive or resistive touch technology. The device in many embodiments will include one or more Data Processing Components 710 for comparing data 708 among different databases.

The computing device 700 can include at least one Input Element (not shown), such as, for example, a push button, touch pad, touchscreen, wheel, joystick, keyboard, mouse, keypad, or any other such component or element whereby a user can input a command to the device. In some embodiments, however, such a device might not include any buttons at all, and might be controlled only through a combination of visual and audio commands, such that a user can control the device without having to be in contact with the device.

The computing device 700 can also include one or more communication elements or networking component 712, such as a Wi-Fi, Bluetooth, RF, wired, or wireless communication system. The device in many embodiments can communicate with a network, such as the World Wide Web or Internet, and may be able to communicate with other such devices.

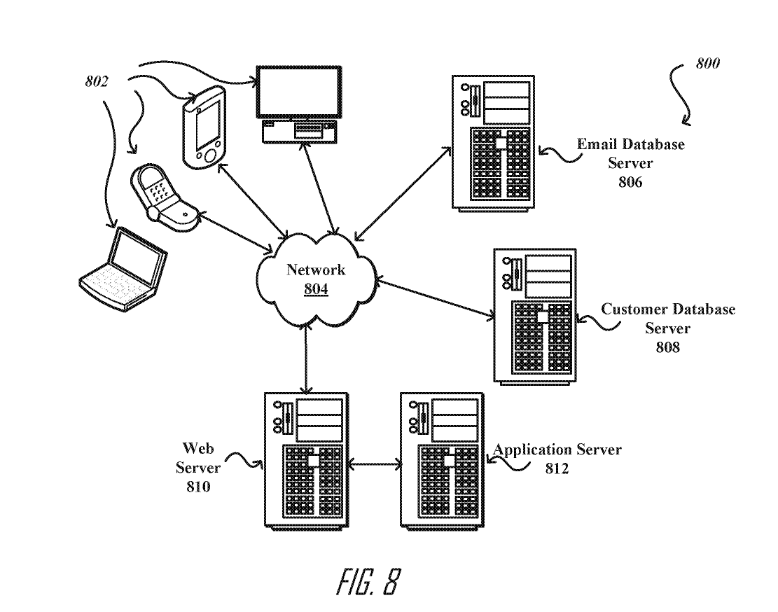

FIG. 8 illustrates an environment in which various embodiments can be implemented, according to some embodiments. FIG. 8 illustrates an example of an environment 800 for implementing aspects in accordance with various embodiments. As will be appreciated, although a Web-based environment is used for purposes of explanation, different environments may be used, as appropriate, to implement various embodiments. The system includes an electronic client device 802, which can include any appropriate device operable to send and receive requests, messages or information over an appropriate network 804 and convey information back to a user of the device. Examples of such client devices include personal computers, cell phones, handheld messaging devices, laptop computers, set-top boxes, personal data assistants, electronic book readers and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server 810 for receiving requests and serving content in response thereto, although for other networks, an alternative device serving a similar purpose could be used, as would be apparent to one of ordinary skill in the art.

The illustrative environment includes at least one Web Server 810, Application Server 812, an email Database Server 806 and a Customer Database Server 808. It should be understood that there can be several application servers, layers or other elements, processes or components, which may be chained or otherwise configured, which can interact to perform tasks such as obtaining data from an appropriate data store. As used herein, the term “database server” refers to any device or combination of devices capable of storing, accessing and retrieving data, which may include any combination and number of data servers, databases, data storage devices and data storage media, in any standard, distributed or clustered environment.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 8. Thus, the depiction of the system 800 in FIG. 8 should be taken as being illustrative in nature and not limiting to the scope of the disclosure.

The various examples can be further implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

Most examples utilize at least one network that would be familiar to those skilled in the art for supporting communications using any of a variety of commercially-available protocols, such as TCP/IP, Bluetooth, OSI, FTP, UPnP, NFS, CIFS, and AppleTalk. The network can be, for example, a local area network, a wide-area network, a virtual private network, the World Wide Web, the Internet, an intranet, an extranet, a public switched telephone network, an infrared network, a wireless network, and any combination thereof.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, EEPROM, flash memory, or other memory technology, CD-ROM, digital versatile disk (DVD) or other optical storage, magnetic cassettes, magnetic tape, magnetic disk storage, or other magnetic storage devices or any other medium which can be used to store the desired information and which can be accessed by a system device. Cloud storage, which takes advantage of the interconnectivity of computing systems that allows multiple processors to manipulate and store data, may also be used. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention.

What is claimed is:

1. A computer-implemented method comprising:
receiving email data related to a recipient, the email data including a first plurality of email messages received at a chronological order;
receiving customer data from a customer database related to the recipient, the customer data including sender information associated with the first plurality of email messages;
determining a respective relevance score associated with each of the first plurality of email messages based at least in part on the email data and the customer data, the respective relevance score indicating a priority level of an email message relative to the recipient;
selecting a second plurality of email messages from the first plurality of email messages based at least in prat on the respective relevance score; and
displaying the second plurality of email messages in a priority order reflecting priorities of the second plurality of email messages relative.

2. The computer-implemented method of claim 1, further comprising:
determining the customer database that is related to the recipient.

3. The computer-implemented method of claim 1, wherein the customer data includes one or more of business relationship data, lead data, account data, contact data, opportunity data and sales data.

4. The computer-implemented method of claim 1, wherein the priority order is generated by sorting the first plurality of email messages based at least in part on the respective relevance score in a descending order.

5. The computer-implemented method of claim 1, wherein selecting the second plurality of email messages from the first plurality of email messages further includes:
filtering at least one email message from the first plurality of email messages, the at least one email message being non-business relevant.

6. The computer-implemented method of claim 1, further comprising:
dividing the second plurality of email messages into one or more categories, each of the one or more categories associated with a distinctive action of the recipient.

7. The computer-implemented method of claim 1, further comprising:
identifying, using one or more natural language processing algorithms, an inquiry indication associated with content of at least one email message, the inquiry indication associated with a high priority level of the at least one email message,
wherein the respective relevance score is based at least in part on the inquiry indication.

8. The computer-implemented method of claim 7, further comprising:
generating a snippet associated with the inquiry indication, the snippet including a content of the inquiry indication; and
displaying the snippet and the second plurality of email messages in the priority order.

9. A system comprising:
one or more processors; and
memory including instructions that, upon being executed by the one or more processors, cause the system to:
receive email data related to a recipient, the email data including a first plurality of email messages received at a chronological order;
receive customer data from a customer database related to the recipient, the customer data including sender information associated with the first plurality of email messages;
determine a respective relevance score associated with each of the first plurality of email messages based at least in part on the email data and the customer data, the respective relevance score indicating a priority level of an email message relative to the recipient;
identify an inquiry indication associated with at least one email message, the inquiry indication associated with a high priority level of the at least one email message,
generate a snippet associated with the inquiry indication, the snippet including a content of the inquiry indication; and
display the snippet and the first plurality of email messages in a priority order reflecting priorities of the second plurality of email messages relative.

10. The system of claim 9, wherein the instructions upon being executed further cause the system to:
filter at least one email message from the first plurality of email messages to generate a second plurality of email messages, the at least one email message being non-business relevant.

11. The system of claim 10, wherein the instructions upon being executed further cause the system to:
divide the second plurality of email messages into one or more categories, each of the one or more categories associated with a distinctive action of the recipient.

12. The system of claim 9, wherein the priority order is generated by sorting the first plurality of email messages based at least in part on the respective relevance score in a descending order.

13. The system of claim 9, wherein the instructions upon being executed further cause the system to:
determine a relationship type between the recipient and the sender for at least one email message; and
display a corresponding tag of the relationship type for the at least one email message.

14. A non-transitory computer-readable storage medium having stored therein instructions that, upon being executed by a processor, cause the processor to:
receive, at one or more processors, email data related to a recipient, the email data including a first plurality of email messages received at a chronological order;
receive customer data from a customer database related to the recipient, the customer data including sender information associated with the first plurality of email messages;
filter at least one email message from the first plurality of email messages to generate a second plurality of email messages, the at least one email message being non-business relevant;
determine a respective relevance score associated with each of the second plurality of email messages based at least in part on the email data and the customer data, the respective relevance score indicating a priority level of an email message relative to the recipient; and
display the second plurality of email messages in a priority order reflecting priorities of the second plurality of email messages relative to the recipient.

15. The non-transitory computer-readable storage medium of claim 14, wherein the instructions upon being executed further cause the processor to:
determine the customer database that is related to the recipient.

16. The non-transitory computer-readable storage medium of claim 14, wherein the priority order is generated by sorting the second plurality of email messages based at least in part on the respective relevance score in a descending order.

17. The non-transitory computer-readable storage medium of claim 14, wherein the instructions upon being executed further cause the processor to:
divide the second plurality of email messages into one or more categories, each of the one or more categories associated with a distinctive action of the recipient.

18. The non-transitory computer-readable storage medium of claim 14, wherein the instructions upon being executed further cause the processor to:
identify, using one or more natural language processing algorithms, an inquiry indication associated with content of at least one email message, the inquiry indication associated with a high priority level of the at least one email message;
generate a snippet associated with the inquiry indication, the snippet including a content of the inquiry indication; and
display the snippet and the second plurality of email messages in the priority order.

19. The non-transitory computer-readable storage medium of claim 14, wherein the customer data includes one or more of business relationship data, lead data, account data, contact data, opportunity data and sales data.

20. The non-transitory computer-readable storage medium of claim 14, wherein the instructions upon being executed further cause the processor to:
determine a relationship type between the recipient and the sender for at least one email message; and
display a corresponding tag of the relationship type for the at least one email message.
